(19) United States
(12) Patent Application Publication
(10) Pub. No.: US 2026/0370935 A1
(43) Pub. Date: Nov. 19, 2026

(54) GROUP CAPTURE ASSISTANT MODE

(71) Applicant: SAMSUNG ELECTRONICS CO., LTD., Suwon-si (KR)

(72) Inventors: Doron Sabo, Tel-Aviv (IL); Sapir Kontente, Tel-Aviv (IL); Roee Sfaradi, Tel-Aviv (IL); Evgeny Artyomov, Tel-Aviv (IL)

(73) Assignee: SAMSUNG ELECTRONICS CO., LTD., Suwon-si (KR)

(21) Appl. No.: 19/208,270

(22) Filed: May 14, 2025

(51) Int. Cl. H04N 23/60; G06T 7/10; G06T 7/73; H04N 23/611; H04N 23/62; H04N 23/63

(52) U.S. Cl. CPC H04N 23/64; G06T 7/10; G06T 7/74; H04N 23/611; H04N 23/62; H04N 23/632; G06T 2207/10016; G06T 2207/20221

(57) ABSTRACT

An electronic device, including: a camera configured to capture a plurality of images including a plurality of objects; and an image signal processor configured to, while the plurality of images are being captured: segment the plurality of images into a plurality of instances, wherein each instance from among the plurality of instances represents an object from among the plurality of objects, extract a plurality of target instances from among the plurality of instances, based on determining that the plurality of target instances satisfy a predetermined condition corresponding to the plurality of objects, and based on determining that the plurality of target instances includes a target instance that satisfies the predetermined condition for each object included in the plurality of objects, generate a fused image based on the plurality of target instances.

### FIELD

The present disclosure relates to image processing, and more particularly to generating a fused group image based on a plurality of images of a group of objects.

### DESCRIPTION OF RELATED ART

Capturing an image of a group of people (e.g., a group image) may be a challenging task, because it may be difficult to capture an image in which each member of the group has an acceptable pose and/or facial expression. For example, even if multiple group images are captured, each group image may include at least one person who is blinking or looking at the wrong direction, blurred movements, or random people (e.g., non-group members) passing through the frame. As the number of people in the group grows, the difficulty may increase. Often, a user may capture a group image only to discover afterwards that it is imperfect, and must therefore be captured again.

Although some approaches exist for improving group images, their functionality may be limited. For example, some approaches provide the ability to mix and match parts of burst images to blend instances representing people across a number of candidate frames into one image. In these systems, the best instance for each person in the group may be selected based on predetermined attributes such as eye openness, face frontal pose, facial expression, etc.

However, these approaches may use an offline editing tool that may require user engagement, and may be tedious and time consuming. For example, these approaches may require the user to review and compare optional suggested target images for each individual in the group. The time and effort associated with post-editing the captured images may deter users from using this editing tool when attempting to capture a group photo quickly. These approaches may also limited to a constant number of collected images (e.g., using burst mode photography systems or a live photo) from which the desired instance for each individual can be selected. However, the collected images may be incomplete for all group members. Moreover, these approaches may suggest an output image in which an instance is selected for each group member based on predefined features, that may not be selected by the user, and may not be tunable.

### SUMMARY

Provided are systems, methods, and devices for generating a group image by fusing portions of a plurality of images of a group.

Additional aspects will be set forth in part in the description which follows and, in part, will be apparent from the description, or may be learned by practice of the presented embodiments.

In accordance with an aspect of the disclosure, an electronic device includes: a camera configured to capture a plurality of images including a plurality of objects; and an image signal processor configured to, while the plurality of images are being captured: segment the plurality of images into a plurality of instances, wherein each instance from among the plurality of instances represents an object from among the plurality of objects, extract a plurality of target instances from among the plurality of instances, based on determining that the plurality of target instances satisfy a predetermined condition corresponding to the plurality of objects, and based on determining that the plurality of target instances includes a target instance that satisfies the predetermined condition for each object included in the plurality of objects, generate a fused image based on the plurality of target instances.

In accordance with an aspect of the disclosure, a method for generating a group image is executed by at least one processor of an electronic device and includes: obtaining a plurality of images including a plurality of objects; while the plurality of images are being obtained: segmenting the plurality of images into a plurality of instances, wherein each instance from among the plurality of instances represents an object from among the plurality of objects; extracting a plurality of target instances from among the plurality of instances based on determining that the plurality of target instances satisfy a predetermined condition corresponding to the plurality of objects; and based on determining that the plurality of target instances includes a target instance that satisfies the predetermined condition for each object included in the plurality of objects, generating a fused image based on the plurality of target instances.

In accordance with an aspect of the disclosure, an electronic device includes at least one processor configured to, while the plurality of images are being obtained: receive a user input identifying a plurality of objects included in the plurality of images, and setting a predetermined condition corresponding to the plurality of objects, segment the plurality of images into a plurality of instances, wherein each instance from among the plurality of instances represents an object from among the plurality of objects, extract a plurality of target instances from among the plurality of instances based on determining that the plurality of target instances satisfy the predetermined condition, and based on determining that the plurality of target instances includes a target instance that satisfies the predetermined condition for each object included in the plurality of objects, generate a fused image based on the plurality of target instances.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system for performing image processing, according to embodiments;

FIG. 2 is a block diagram of an electronic device including the image processing system of FIG. 1, according to embodiments;

FIG. 3 is a diagram showing an example of an input image, according to embodiments;

FIGS. 4 and 5 are diagrams showing examples of preview images, according to embodiments;

FIG. 6 is a diagram showing an example of an enhanced group image, according to embodiments;

FIG. 7 is a block diagram illustrating a process for generating an enhanced group image, according to embodiments; and

FIGS. 8-9 are flowcharts of example processes for generating an enhanced group image, according to embodiments.

### DETAILED DESCRIPTION

As discussed above, it may be difficult to capture an image of a group of people (e.g., a group image) in which each person in the group has a desired pose and/or facial expression.

Embodiments of the present disclosure are directed to techniques for obtaining an enhanced group image in which all of the people in the group satisfy a predetermined condition, which may for example relate to at least one of a pose and an expression selected by the user obtaining the image. For example, in some embodiments the user may set the same predetermined condition for all group members, or may set different conditions for one or more of the group members. Embodiments may generate a preview image which may provide a preview of the enhanced group image by mixing image data obtained from a plurality of different images of the group as they are captured. Accordingly, embodiments may provide an immediate user feedback to indicate whether appropriate images have been collected for each member of the group. In some embodiments, the user may provide input indicating whether each individual in the image is intended to be included in the group, and individuals which are not included in the group may be ignored and/or removed from the enhanced group image. Accordingly, embodiments may assist a user in obtaining a group image in which each member of the group exhibits desired characteristics such as pose and facial expression, by capturing a plurality of input images and merging portions of them into an enhanced group image. Embodiments may provide feedback to the user while the images are being captured, and may continue capturing the images until acceptable target images are obtained for all of the members of the group. Embodiments may also provide a preview image which previews the final enhanced group image.

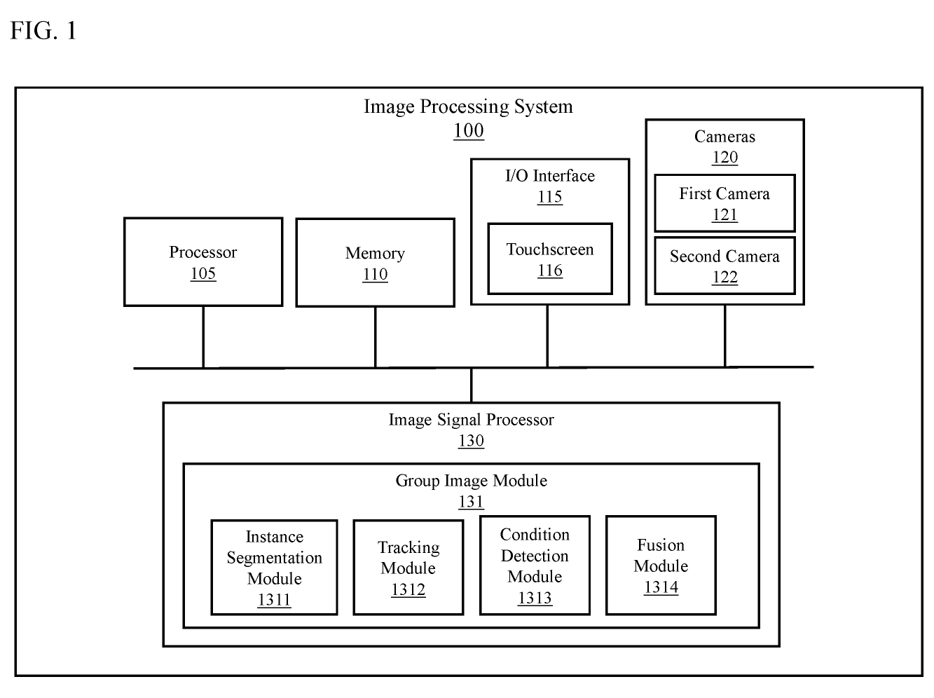

FIG. 1 is a block diagram of a system for performing image processing, according to embodiments. As shown in FIG. 1, the image processing system 100 may include a processor 105, a memory 110, an input/output (I/O) interface 115, one or more cameras 120, and an image signal processor (ISP) 130.

The processor 105 may be, or may include, an intelligent hardware device, e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 105 may be configured to operate a memory array using a memory controller. For example, a memory controller may be integrated into the processor 105. In embodiments, the processor 105 may be configured to execute computer-readable instructions stored in a memory to perform various functions. However, embodiments are not limited thereto, and the memory controller may be included in any other element of the image processing system 100, for example in the memory 110.

The memory 110 (e.g., a memory device) may include at least one of a random access memory (RAM), a read-only memory (ROM), and a hard disk. For example, the memory 110 may include a solid state memory and a hard disk drive. The memory 110 may be used to store computer-readable and computer-executable software including instructions which, when executed, may cause the processor 105 to perform various functions described herein. For example, the memory 110 may include, among other things, a basic input/output system (BIOS) which may control basic hardware or software operation such as the interaction with peripheral components or devices. In some cases, memory cells within the memory 110 store information in as a logical state of the memory cells.

The I/O interface 115 may manage signals which are input from and output to the image processing system 100 and the elements included therein. The I/O interface 115 may also manage peripherals which are not integrated into a device. For example, the I/O interface 115 may represent a physical connection or port to an external peripheral. In embodiments, the I/O interface 115 may utilize an operating system such as iOS®, ANDROID®, MS-DOS®, MS-WINDOWS®, OS/2®, UNIX®, LINUX®, or another operating system. In embodiments, the I/O interface 115 may represent, include or interact with a modem, a keyboard, a mouse, or a similar device. In embodiments, the I/O interface may include a touchscreen 116, which may be used to display images and receive touch inputs from a user. In embodiments, the I/O interface 115 may be implemented as part of a processor 105. In embodiments, a user may interact with a device using the I/O interface 115 or using hardware components controlled by the I/O interface 115.

The image processing system 100 may include an optical instrument (e.g., one or more cameras 120, an image sensor, etc.) for recording or capturing images, which may be stored locally, transmitted to another location, etc. For example, the cameras 120 may capture visual information using one or more photosensitive elements that may be tuned for sensitivity to a visible spectrum of electromagnetic radiation. A resolution of the visual information may be measured in pixels, where each pixel may relate an independent piece of captured information. In embodiments, each pixel may correspond to one component of, for example, a two-dimensional (2D) Fourier transform of an image. Computation methods may use pixel information to reconstruct images captured by the device. In the camera 120, one or more image sensors may convert light incident on a lens of the camera 120 into an analog or digital signal. The image processing system 100 may then display an image on a display panel (e.g., the touchscreen 116) based on the digital signal. In embodiments, the one or more cameras 120 may include, for example, a first camera 121 and a second camera 122.

A pixel (e.g., a pixel sensor) may store information about received electromagnetic radiation (e.g., light). Each pixel may include one or more photodiodes and one or more complementary metal oxide semiconductor (CMOS) transistors. A photodiode may receive a light and may output charges. The amount of output charges may be proportional to the amount of light received by the photodiode. CMOS transistors may output a voltage based on charges output from the photodiode. A level of a voltage output from the photodiode may be proportional to the amount of charges output from the photodiode. For example, the level of the voltage output from a photodiode may be proportional to the amount of light received by the photodiode.

The ISP 130 may perform image processing on an image obtained through the cameras 120, or image data stored in the memory 110. Image processing may include depth map generation, three-dimensional modeling, panorama generation, feature point extraction, image synthesis, and/or image compensation (e.g., noise reduction, resolution adjustment, brightness adjustment, blurring, softening, etc.). The ISP 130 may control (e.g., exposure time control, lead out timing control, etc.) other components (e.g., image sensors, etc.) included in the first camera 121 and/or the second camera 122. An image treated or processed by the ISP 130 may be stored again in the memory 110 for further processing or may be provided to another component (e.g., the I/O interface 115, the touchscreen 116, etc.). The ISP 130 may be integrated into the processor 105 or may be a separate processor operating independently of the processor 105. If the ISP 130 is a separate processor from the processor 105, an image processed by the ISP 130 may be displayed through the touchscreen 116 after going through an additional image processing by the processor 105.

The ISP 130 may include a group image module 131. As shown in FIG. 1, the group image module 131 may include an instance segmentation module 1311, a tracking module 1312, a condition detection module 1313, and a fusion module 1314. According to embodiments, the group image module 131 may be used to combine or fuse portions of a plurality of input images in order to generate an enhanced group image in which each member of the group satisfies a predetermined condition, for example a desired pose or facial expression. For example, the instance segmentation module 1311 may analyze an image included in the plurality of image and segment the image into a plurality of instances corresponding to the group members, the tracking module 1312 may track each member of the group within the segmented image, the condition detection module 1313 may determine whether each instance segmented from the image satisfies the predetermined condition, and the fusion module 1314 may fuse or combine acceptable instances to generate the enhanced group image. Example operations of the group image module 131 and the elements included therein are described in greater detail below.

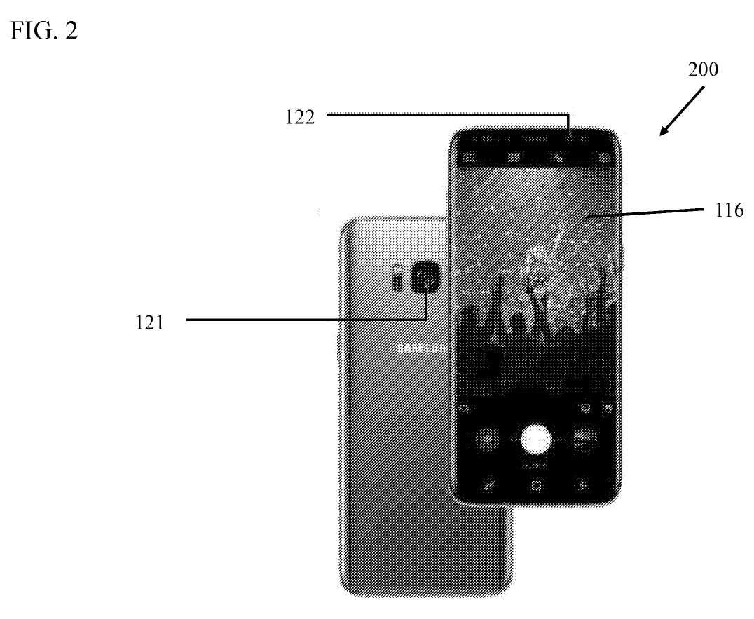

FIG. 2 is a block diagram of an electronic device including the image processing system of FIG. 1. In some embodiments, the electronic device 200 may be a mobile device such as a smartphone, but embodiments are not limited thereto. For example, according to embodiments, the electronic device 200 may be, or may include, a personal computer, a laptop computer, a tablet computer, a personal digital assistant, or any other type of electronic device. In embodiments, the electronic device 200 may include, or may be used to implement, the image processing system 100 and/or one or more of the components included therein, for example the ISP 130 and the components included therein.

As shown in FIG. 2, the electronic device 200 may include the first camera 121, the second camera 122, and the touchscreen 116. As shown in FIG. 2, the first camera 121 may face or be oriented in opposite directions with respect to the electronic device 200. For example, the first camera 121 may be oriented toward a first direction (e.g., a rear direction) with respect to the electronic device 200, the second camera 122 may be oriented toward a second direction (e.g., a front direction) with respect to the electronic device, and the first direction may be opposite to the second direction. Accordingly, the first camera 121 may be a rear-facing camera included in the electronic device 200, and the second camera 122 may be a front-facing camera included in the electronic device 200.

The electronic device 200 may use the touchscreen 116 to display images such as one or more of the first image captured by the first camera 121, the second image captured by the second camera 122, a preview image generated based on the first image or the second image, a fused image generated based on the first image or the second image, and any other image described herein with reference to FIGS. 1-9. In addition, the electronic device 200 may use the touchscreen 116 to display one or more user interfaces and to receive one or more user inputs.

As discussed above, embodiments may relate to systems, methods, and devices for obtaining group images. For example, according to embodiments, a device such as the electronic device 200 may display a user interface which may allow a user to activate a mode for capturing a group image, which may be referred to for example as a group capture assistant mode. The user interface may also allow the user to provide or select a predetermined condition related to the group image, which may include at least one of a desired pose and a desired facial expression for one or more of the members of the group. For example, the user may provide a text input such as “a photo of a person looking at the camera and smiling” or “a photo of a person jumping and smiling”. However, embodiments are not limited thereto, and in some embodiments the predetermined condition may be selected by the user from a list, or may be set by default. In addition, the user may set a different condition for one or more members of the group. Based on the group capture assistant mode being activated, the electronic device 200 may begin capturing a plurality of input images, for example using at least one of the cameras 120.

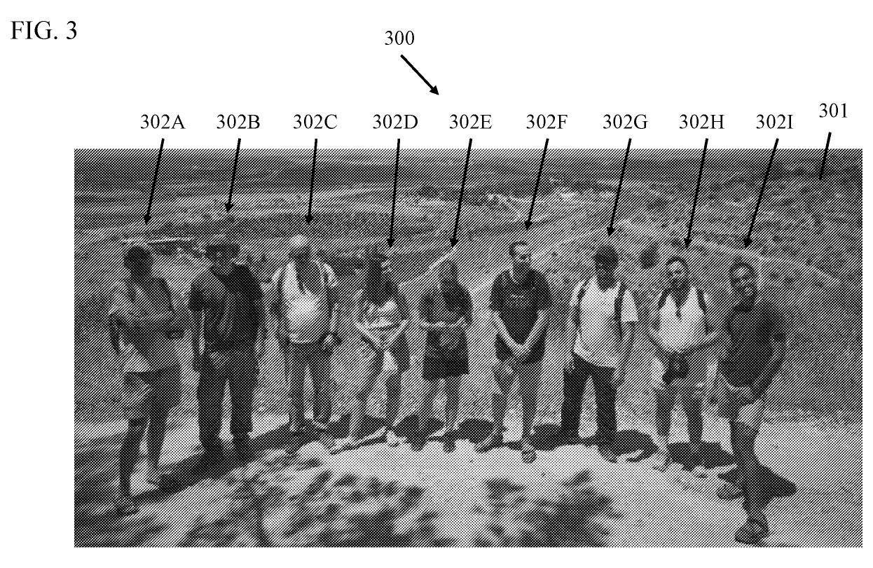

FIG. 3 is a diagram showing an example of an input image, according to embodiments. As shown in FIG. 3, the input image 300 may include a background 301 and a plurality of objects 302. According to embodiments, each of the plurality of objects 302 may be a human person, and the plurality of objects 302 may correspond to members of a group. For example, the plurality of objects 302 may include a first object 302A (e.g., a first person), a second object 302B (e.g., a second person), a third object 302C (e.g., a third person), a fourth object 302D (e.g., a fourth person), a fifth object 302E (e.g., a fifth person), a sixth object 302F (e.g., a sixth person), a seventh object 302G (e.g., a seventh person), an eighth object 302H (e.g., an eighth person), and a ninth object 302I(e.g., a ninth person). However, embodiments are not limited thereto, and the objects 302 may be objects that are not humans, for example animals, plants, or inanimate objects (e.g., a flag, etc).

According to embodiments, the input image 300 may be included in a plurality of images which are captured while the electronic device 200 operates in the group capture assistant mode. Therefore, the group image module 131 may obtain the input image 300 and may use at least a portion of the input image 300 to generate the enhanced group image. A portion of the input image 300 (e.g., a portion of the image data and/or pixel associated with the input image 300) which corresponds to or which represents a particular object 302 may be referred to as an instance of the object 302. For example, the input image 300 may include a plurality of instances corresponding to the plurality of objects 302 (e.g., an instance of the first object 302A, an instance of the second object 302B, an instance of the third object 302C, an instance of the fourth object 302D, an instance of the fifth object 302E, an instance of the sixth object 302F, an instance of the seventh object 302G, an instance of the eighth object 302H, and an instance of the ninth object 302I).

According to embodiments, the electronic device 200 may display one or more preview images while the plurality of images are being captured. For example, in some embodiments the preview image may include an image that is currently being captured by the electronic device (e.g., a live view image), and may further include information which provides feedback to the user, for example one or more indicators which indicate whether appropriate images have been captured or collected for each member of the group. As another example, the preview image may include a preview version of the final enhanced group image, which may be constructed by the electronic device in real time by extracting instances of the group members which satisfy the predetermined condition from the input images and combining or fusing the instances together. As yet another example, the preview image may include both the live view image with the feedback information and the preview version of the final enhanced group image. Examples of the preview images are described in greater detail below.

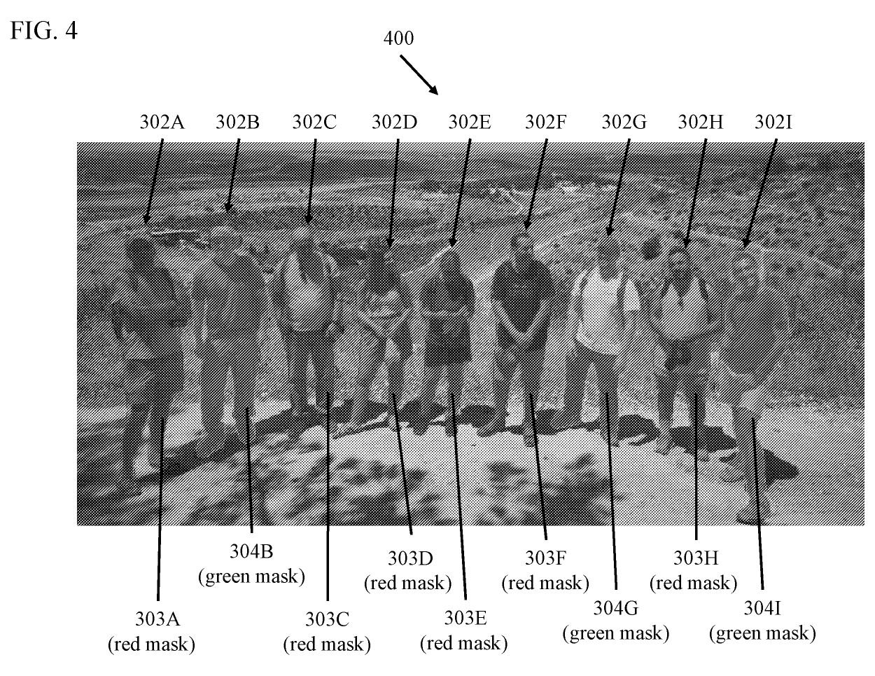

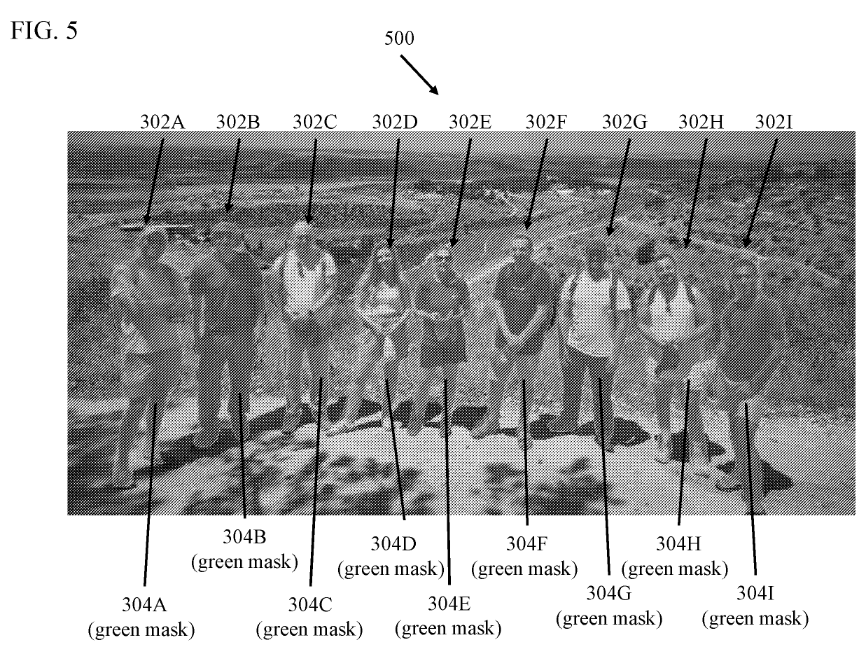

FIGS. 4 and 5 are diagrams showing an examples of preview images, according to embodiments. The group image module 131 may detect a boundary region corresponding to an instance of each object 302, and may provide an indicator corresponding to the object 302, which may indicate a status of the group capture assistant mode with respect to each object 302 (e.g., may indicate whether an instance that satisfies the predetermined condition has been collected for the object 302). According to embodiments, an instance of an object 302 which satisfies the predetermined condition may be referred to as a target instance of the object 302, and an image which includes the target instance may be referred to as a target image corresponding to the object 302.

FIG. 4 illustrates a preview image 400 in which the indicators are presented as masks which are overlaid onto the instances of the objects 302. In some embodiments, the masks may have different colors or textures which may indicate whether or not a target instance of the object 302 has been collected (e.g., whether or not a target image corresponding to the object 302 has been captured). For example, a red mask 303 may indicate that a target instance of the object 302 has not yet been collected, and may therefore be referred to as a negative indicator, and a green mask 304 may indicate that a target instance of the object 302 has been collected, and may therefore be referred to as a positive indicator.

As shown in FIG. 4, the preview image 400 may include a red mask 303A overlaid onto an instance of the first object 302A, a green mask 304B overlaid onto an instance of the second object 302B, a red mask 303C overlaid onto an instance of the third object 302C, a red mask 303D overlaid onto an instance of the fourth object 302D, a red mask 303E overlaid onto an instance of the fifth object 302E, a red mask 303F overlaid onto an instance of the sixth object 302F, a green mask 304G overlaid onto an instance of the seventh object 302G, a red mask 303H overlaid onto an instance of the eighth object 302H, and a green mask 304I overlaid onto an instance of the ninth object 302I. Accordingly, an input image corresponding to the preview image 400 may be a target image corresponding to the second object 302B, the seventh object 302G, and the ninth object 302I, and a target instance of each of these objects may be extracted and used to generate the enhanced group image.

The indicators may also be used to indicate other information. In some embodiments, if an input image includes a person who is not included in the group, the instance of the non-group member may be overlaid with a gray mask in the preview image. For example, when the group capture assistant mode is first activated, no target instances have been acquired for any of the objects 302. Therefore, the electronic device 200 may display a preview image in which all of the objects 302 are overlaid with a red mask, and the group image module 131 may begin tracking the objects 302. As subsequent input images are captured, the red masks may be changed to green masks as target instances are collected for the objects 302. Then, if a new input image is captured which includes a new object 302, this new object 302 may be initially identified as non-group members, and may therefore be overlaid with a gray mask.

In some embodiments, the first image of the plurality of images (e.g., the first image captured after the group image assistant mode is activated) may be selected as a reference image, and the target images may be is automatically identified and selected based on the predetermined condition. After a target image is captured for an object 302, a positive indicator may be provided for the object 302 in a preview image that corresponds to the target image, as well as in subsequent preview images. In some embodiments, the reference image may be displayed as a preview image, and may be updated as target instances are collected. For example, when a target instance of an object 302 is collected, a reference instance of the object 302 which is included the preview image may be replaced with the target instance. For example, this may mean that image data or pixel data representing the object 302 may be extracted from the target image, and may replace image data or pixel data representing the object 302 in the preview image. However, embodiments are not limited thereto. For example, in some embodiments, the preview image may include a live view image that includes each input image as it is captured in real time, and the indicators (e.g., the masks) may be added to the live view image.

The electronic device 200 may continue capturing the plurality of images until a target image has been captured for all of the objects 302. Once all of the target images have been captured, the group capture assistant mode may be deactivated, and the final enhanced group image may, which may include an acceptable instance of each object 302, may be generated and displayed.

FIG. 5 illustrates another preview image 500 in which the indicators are presented as masks which are overlaid onto the instances of the objects 302. As shown in FIG. 5, the preview image 500 may include green mask 304A overlaid onto an instance of the first object 302A, a green mask 304B overlaid onto an instance of the second object 302B, a green mask 304C overlaid onto an instance of the third object 302C, a green mask 304D overlaid onto an instance of the fourth object 302D, a green mask 304E overlaid onto an instance of the fifth object 302E, a green mask 304F overlaid onto an instance of the sixth object 302F, a green mask 304G overlaid onto an instance of the seventh object 302G, a green mask 304H overlaid onto an instance of the eighth object 302H, and a green mask 304I overlaid onto an instance of the ninth object 302I. Accordingly, when the preview image 500 is displayed, this may indicate to the user that target images have been captured for all of the objects 302, and therefore that the electronic device 200 has collected enough images to generate the enhanced group image.

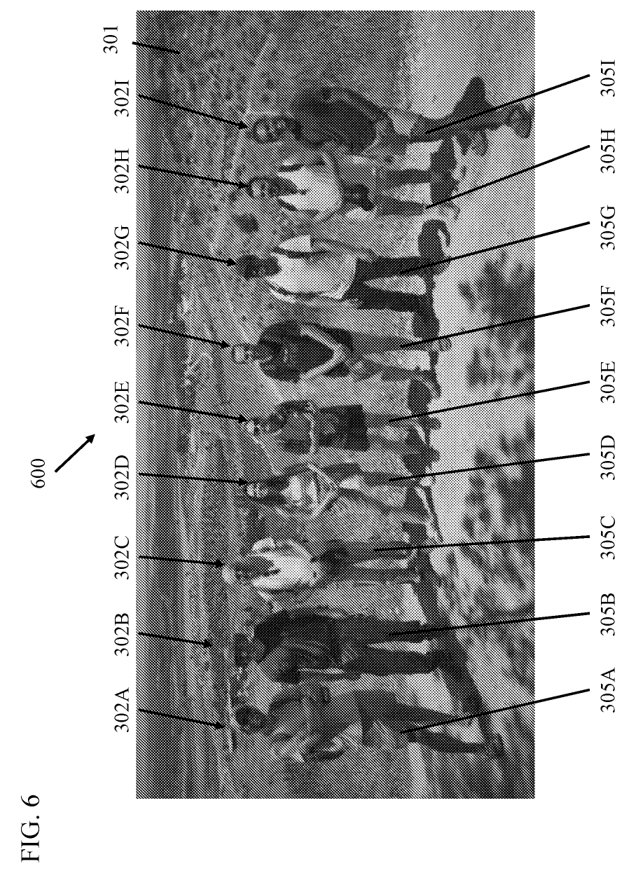

FIG. 6 is a diagram showing an example of an enhanced group image, according to embodiments. According to embodiments, the enhanced group image may include a background obtained from one or more input images (e.g., a background of the reference image) and the target instances of the objects 302 that were detected and tracked during the capturing of the plurality of input images. For example, as shown in FIG. 6, an enhanced group image may include the background 301 from the image 300, and a plurality of target instances corresponding to the plurality of objects 302 (e.g., a target instance 305A of the first object 302A, a target instance 305B of the second object 302B, a target instance 305C of the third object 302C, a target instance 305D of the fourth object 302D, a target instance 305E of the fifth object 302E, a target instance 305F of the sixth object 302F, a target instance 305G of the seventh object 302G, a target instance 305H of the eighth object 302H, and a target instance 305I of the ninth object 302I), which may be extracted from one or more target images from among the plurality of input images.

The group image module 131 may automatically identify other objects (e.g., other people) as a non-group members, and instances of these other objects may be marked with indicators (e.g., gray masks) to indicate that these instances will be ignored in the final enhanced group image. According to embodiments, an object that is marked as an ignored object (e.g., overlaid with a gray mask) may be excluded from or otherwise not appear in the final enhanced group image. For example, in some embodiments, the ignored object may be replaced with a corresponding portion of the background. In some embodiments, the user may provide an input associated with the indicator corresponding to the new object (e.g., a tap input on the gray mask displayed in the preview image) to indicate that this new object should be added to the group, and the group image module 131 may begin tracking the new object and collect a target instance of the new object to be included in the enhanced group image. In addition, the user may provide an input associated with an indicator corresponding to an object 302 (e.g., a tap input on a red mask or green mask displayed in the preview image) to indicate this object should be removed from the group, and therefore ignored when generating the final enhanced group image. In addition, if the user determines that a target instance that is collected for an object is unacceptable for some reason despite the target instance satisfying the predetermined condition, the user may provide an input requesting that the target instance be discarded, and a new target instance be collected for the object 302.

In some embodiments, the user may wish for an object 302 to be represented multiple times in the enhanced group image. Therefore, after a target instance is collected for the object 302, the user may provide an input requesting that the group image module 131 collect an additional target instance for the object 302 (e.g., by providing a tap input corresponding to an instance of the object 302 that is already overlaid with a green mask 304) and the image module may begin tracking the object 302 as if it is a new object while maintaining the previously collected target instance of the object 302. In addition, the user may specify a new predetermined condition (e.g., a new pose and/or a new facial expression) that is different from the previous predetermined condition for the object 302. This can be repeated so that it is possible to collect many instances of each group member, possibly with different poses and/or expressions.

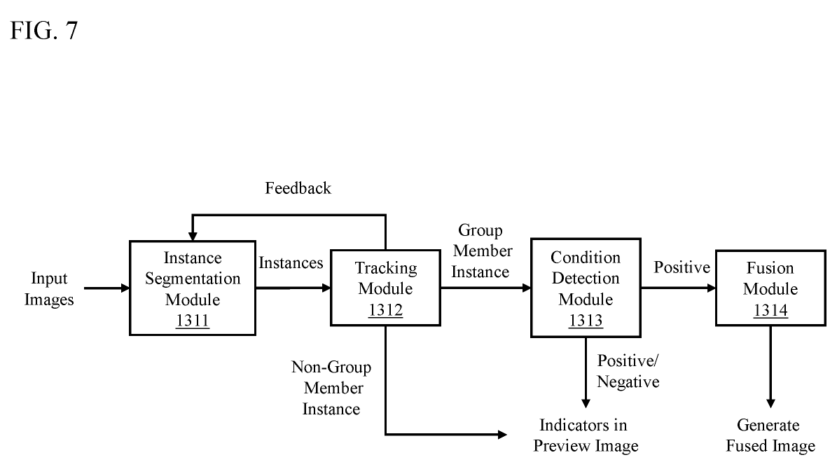

FIG. 7 is a block diagram illustrating a process for generating an enhanced group image, according to embodiments. As shown in FIG. 7, the instance segmentation module 1311 may detect the boundaries of the objects 302 (e.g., the instances) within each input image, and may provide information about the boundaries (e.g., locations of image data or pixels corresponding to, or included in, the boundaries) to the tracking module 1312. In embodiments, the instance segmentation module 1311 may include an artificial intelligence (AI) model such as an image segmentation model, which may be trained to detect objects in an image, and to partition the image into groups of pixels corresponding to the objects in order to detect the boundaries.

The tracking module 1312 may track a location of each object 302 within the input images as they are obtained. For example, the tracking module 1312 may assist in determining whether an object is, or should be, included in the group, for example by determining whether the object remains mostly still, or passes through the group as the input images progress. In addition, the tracking module 1312 may be used to locate areas within some of the input images which are occluded by the objects 302, or by other objects, so that image data corresponding to these areas may be extracted from other input images and used to fill in these occlusions in the final enhanced group image. The tracking module 1312 may also provide feedback information to the instance segmentation module 1311, which may use the feedback information to validate and enhance the overall accuracy of the instance segmentation detections. By tracking the position of each group member, the tracking module 1312 may determine a most likely position in a next input image, and add or remove indicators (e.g., masks)based on this most likely position. In some embodiments, the tracking module 1312 may include an AI model, or the tracking module 1312 may be implemented classically.

The condition detection module 1313 may analyze the instances of the objects 302 (or the objects 302 identified as group members by the tracking module 1312) and determine whether the predetermined condition is satisfied for each instance. For example, the condition detection module 1313 may include an AI facial landmark detection model which may be trained to detect and localize specific points or landmarks on a face (e.g., the eyes, nose, mouth, and chin) in order to accurately identify these landmarks in the input images, in real-time, and use them for facial expression analysis and head pose estimation. In addition, the condition detection module 1313 may include an AI skeletal landmark detection model trained to identify skeletal landmarks in order to estimate poses of the objects 302 (e.g. “jumping”). In some embodiments, the condition detection module 1313 may include an image-text classifier model (e.g. a contrastive language-image pre-training (CLIP) model) which may be used to classify whether or not an instance corresponds to the user input setting the predetermined condition. For example, based on the user providing an input text that indicates a desired pose (or based on the user selecting a predefined text template) the image-text classifier model may provide an output indicating whether an instance corresponds to the text. Accordingly, the condition detection module 1313 may evaluate each instance, and may provide either an output indicating that the predetermined condition is satisfied (e.g., a positive output), or an output indicating that the predetermined condition is not satisfied (e.g., a negative output). Based on this positive or negative output, the group image module 131 may update the indicators included in the preview images (e.g., may change the colors of the masks) accordingly, and may collect the target instances of the objects 302.

The fusion module 1314 may fuse, blend, or otherwise combine the target instances of the objects 302 that are identified as group members in order to generate the final enhanced group image. According to embodiments, after the target instances are collected and fused into a single combined image, the combined image may have issues. For example, some image information may be missing and/or occluded, the target instances may not be properly aligned (e.g., due to small changes in the position of the camera or movements by the objects 302) and the brightness might not be identical between all of the target images (e.g., due to changing lighting conditions, flickering lights, etc.). Therefore, the fusion module 1314 may perform at least one of frame alignment, brightness adjustment, color adjustment, and refilling or inpainting of the missing or occluded image information in order to generate the final enhanced group image.

To perform frame alignment (e.g., alignment between a target image and a reference image) the fusion module 1314 may detect key points in a target image, match the key points between the target image and the reference image, and then perform optimization and homography on the two images. To perform the brightness adjustment and/or the color adjustment, the fusion module 1314 may collect statistics for a brightness and/or a color of the same objects included in both the target image and the reference image, and may optimize for a gain/color matrix that matches them.

According to embodiments, the fusion module 1314 may seamlessly blend portions of the target images into the reference image while filling holes where information is missing, using an AI reference-guided inpainting model. Reference-guided inpainting may refer to restoring missing pixels within a hole region that was removed from an image (e.g., instances in the reference image that do not satisfy the predetermined condition) by referring to another image that shares scene content with the image (e.g., one or more target images). Therefore, in addition the target instances, the fusion module 1314 may also use additional information obtained from the target images in order to fill in occlusions or holes in the reference image which are not entirely filled by the target instances. In addition, the fusion module 1314 may modify or correct the target instances in order to generate a more cohesive final enhanced group image. According to embodiments, multiple target images may be used to provide the guidance and the additional information, which may improve the performance of the inpainting model and/or the fusion module 1314.

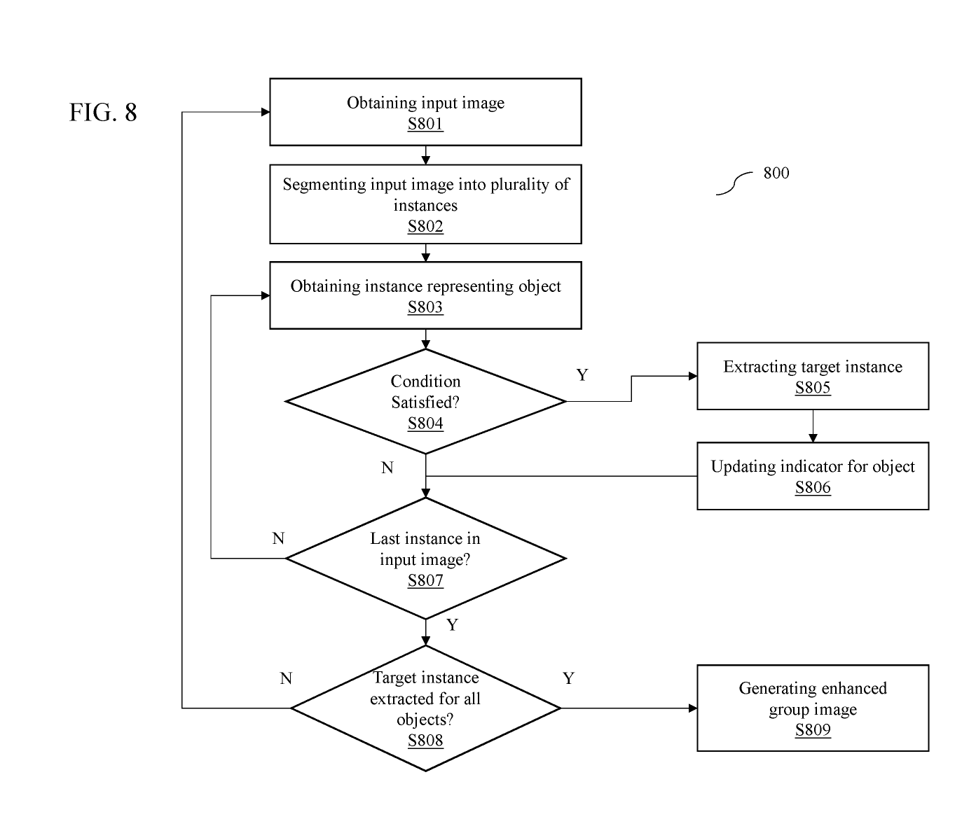

FIG. 8 is a flowchart of an example process for generating a combined image, according to embodiments. In some implementations, one or more process blocks of FIG. 8 may be performed by any of the elements discussed above, for example one or more of the image processing system 100, the electronic device 200, and any of the components included therein, such as ISP 130, and the group image module 131.

As shown in FIG. 8, at operation S801 the process 800 may include obtaining an input image.

As further shown in FIG. 8, at operation S802 the process 800 may include segmenting the input image into a plurality of instances. In embodiments, the plurality of instances may represent a plurality of objects, for example the objects 302.

As further shown in FIG. 8, at operation S803 the process 800 may include obtaining an instance of an object from the input image. In embodiments, the object may be an object 302, which may be a member of a group for which an enhanced group image is to be generated. The object may be included in the group based on a user input received from a user.

As further shown in FIG. 8, at operation S804 the process 800 may include determining whether the instance satisfies a predetermined condition. In embodiments, the predetermined condition may be satisfied based on the object being in particular pose, or based on the object exhibiting a particular facial expression. The predetermined condition may be set or determined based on a user input received from a user.

Based on determining that the instance satisfies the predetermined condition (Y at operation S804), the process 800 may proceed to operation S805 and operation S806. At operation S805, the process 800 may include collecting the input image as a target image corresponding to the object, and collecting or extracting the instance as a target instance of the object. In embodiments, the target instance may be used to generate the enhanced group image. At operation S806, an indicator corresponding to the object (e.g., a mask overlaid onto the object) included in a preview image may be updated to indicate that the target instance of the object has been extracted.

Based on determining that the instance does not satisfy the predetermined condition (N at operation S804), the process 800 may proceed to operation S805, which may include determining whether the instance is the last instance included in the input image.

Based on determining that the instance is not the last instance included in the input image (N at operation S807), the process 800 may return to operation S803, and an instance of a next object may be evaluated.

Based on determining that the instance is the last instance included in the input image (Y at operation S807), the process 800 may proceed to operation S808, which may include determining whether a target instance has been extracted for all of a plurality of objects included in the group.

Based on determining that a target instance has been extracted for all of the plurality of objects included in the group (Y at operation S808), the process 800 may proceed to operation S809, which may include generating the enhanced group image based on the extracted target images.

Based on determining that a target instance has not been extracted for all of the plurality of objects included in the group (N at operation S808), the process 800 may return to operation S801, which may include obtaining a next input image. Accordingly, the electronic device 200 may continue to capture input images until target images are captured for all of the plurality of objects included in the group, and a target instance is extracted for each of the plurality of objects included in the group.

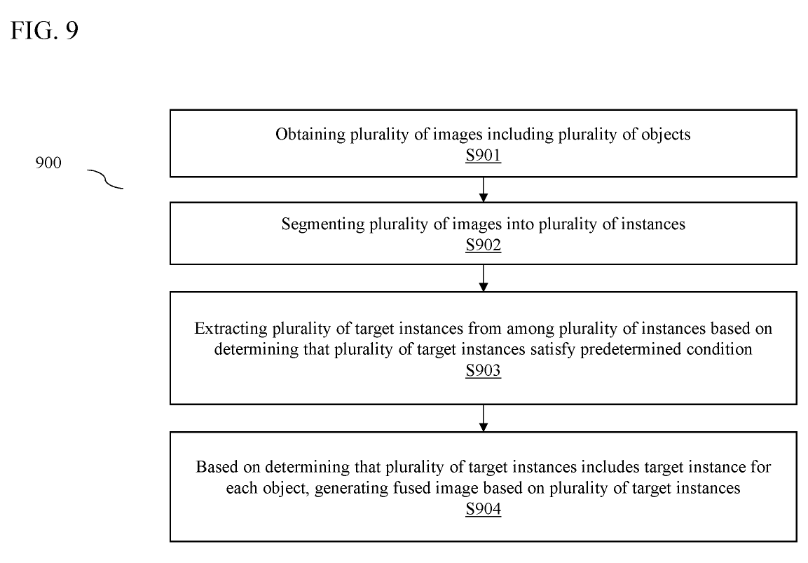

FIG. 9 is a flowchart of an example process for generating a combined image, according to embodiments. In some implementations, one or more process blocks of FIG. 8 may be performed by any of the elements discussed above, for example one or more of the image processing system 100, the electronic device 200, and any of the components included therein, such as ISP 130 and the group image module 131.

As shown in FIG. 9, at operation S901 the process 900 may include obtaining a plurality of images including a plurality of objects. In embodiments, the plurality of images may correspond to the plurality of input images discussed above, and the plurality of objects may correspond to the plurality of objects 302 discussed above.

According to embodiments, the operations S902, S903, and S904 may be performed while the operation S901 is performed (e.g., while the plurality of images are being obtained).

As further shown in FIG. 9, at operation S902 the process 900 may include segmenting the plurality of images into a plurality of instances. In embodiments, each instance from among the plurality of instances may represent an object from among the plurality of objects.

As further shown in FIG. 9, at operation S903 the process 900 may include extracting a plurality of target instances from among the plurality of instances based on determining that the plurality of target instances satisfy a predetermined condition corresponding to the plurality of objects.

As further shown in FIG. 9, at operation S904 the process 900 may include, based on determining that the plurality of target instances includes a target instance that satisfies the predetermined condition for each object included in the plurality of objects, generating a fused image based on the plurality of target instances. In embodiments, the fused image may correspond to the enhanced group image discussed above.

In embodiments, the process 900 may further include displaying a preview image while the plurality of images are being obtained. The preview image may include a plurality of indicators corresponding to the plurality of objects, and each indicator from among the plurality of indicators may indicate whether a target instance that satisfies the predetermined condition has been extracted for a corresponding object from among the plurality of objects.

In embodiments, each indicator may include a mask overlaid onto the corresponding object, and at least one of a color and a texture of the mask may indicate whether a target instance that satisfies the predetermined condition has been extracted for the corresponding object.

In embodiments, the plurality of images may further include at least one additional object that is not included in the plurality of objects, the preview image may further include at least one additional indicator corresponding to the at least one additional object, wherein the at least one additional indicator indicates that the at least one additional object is to be excluded from the fused image, and the process 900 may further include, based on a user input received from a user of the electronic device, adding the at least one additional object to the plurality of objects, and modifying the at least one additional indicator to indicate that the at least one additional object is to be included in the fused image. In embodiments, the at least one additional indicator may correspond to the gray masks discussed above.

In embodiments, operation S903 may further include: segmenting a first image from among the plurality of images into a plurality of first instances corresponding to the plurality of objects; based on determining that a first instance from among the plurality of first instances satisfies the predetermined condition with respect to a first object from among the plurality of objects, extracting the first instance as a first target instance; and updating a first indicator corresponding to the first object from among the plurality of objects to indicate that the first target instance has been extracted.

In embodiments, operation S903 may further include: after the first indicator is updated, segmenting a second image from among the plurality of images into a plurality of second instances corresponding to the plurality of objects; based on determining that a second instance from among the plurality of second instances satisfies the predetermined condition with respect to a second object from among the plurality of objects, extracting the second instance as a second target instance; and updating a second indicator corresponding to the second object from among the plurality of objects to indicate that the second target instance has been extracted.

In embodiments, operation S903 may further include, based on receiving a user input corresponding to the first indicator after the first indicator is updated, updating the first indicator to indicate that an additional first target instance is to be extracted, segmenting a third image from among the plurality of images into a plurality of third instances corresponding to the plurality of objects; based on determining that a third instance from among the plurality of third instances satisfies the predetermined condition with respect to the first object from among the plurality of objects, extracting the third instance as the additional first target instance; and updating the first indicator to indicate that the additional first target instance has been extracted. In embodiments, the fused image may include the first target instance and the additional first target instance.

In embodiments, the fusing may include performing at least one from among a frame alignment between the plurality of target instances, a brightness matching among the plurality of target instances, a color matching among the plurality of target instances, and inpainting a missing portion of at least one of the plurality of target instances.

In embodiments, the plurality of objects may include a plurality of humans, and the predetermined condition may correspond to at least one of a pose and a facial expression associated with the plurality of humans.

In embodiments, the at least one of the pose and the facial expression may be determined based on a user input received from a user of the electronic device.

In embodiments, at least one from among the segmenting the plurality of images, the determining that the plurality of target instances satisfy the predetermined condition, and the generating of the fused image is performed by providing the plurality of images to an AI model.

Although FIGS. 8 and 9 show example blocks of the processes 800 and 900, in some implementations, the processes 800 and 900 may include additional blocks, fewer blocks, different blocks, or differently arranged blocks than those depicted in the processes 800 and 900. Additionally, or alternatively, two or more of the blocks of the processes 800 and 900 may be arranged or combined in any order, or performed in parallel.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any "processor-readable medium" for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. An electronic device, comprising:
a camera configured to capture a plurality of images comprising a plurality of objects; and
an image signal processor configured to, while the plurality of images are being captured:
segment the plurality of images into a plurality of instances, wherein each instance from among the plurality of instances represents an object from among the plurality of objects,
extract a plurality of target instances from among the plurality of instances, based on determining that the plurality of target instances satisfy a predetermined condition corresponding to the plurality of objects, and
based on determining that the plurality of target instances include a target instance that satisfies the predetermined condition for each object included in the plurality of objects, generate a fused image based on the plurality of target instances.

2. The electronic device of claim 1, wherein the image signal processor is further configured to generate a preview image while the plurality of images are being captured,
wherein the preview image comprises a plurality of indicators corresponding to the plurality of objects, and
wherein each indicator from among the plurality of indicators indicates whether the target instance that satisfies the predetermined condition has been extracted for a corresponding object from among the plurality of objects.

3. The electronic device of claim 2, wherein each indicator comprises a mask overlaid onto the corresponding object, and
wherein at least one of a color and a texture of the mask indicates whether the target instance that satisfies the predetermined condition has been extracted for the corresponding object.

4. The electronic device of claim 2, wherein the plurality of images further comprise at least one additional object that is not included in the plurality of objects,
wherein the preview image further comprises at least one additional indicator corresponding to the at least one additional object, wherein the at least one additional indicator indicates that the at least one additional object is to be excluded from the fused image, and
wherein the image signal processor is further configured to, based on a user input received from a user of the electronic device, add the at least one additional object to the plurality of objects, and modify the at least one additional indicator to indicate that the at least one additional object is to be included in the fused image.

5. The electronic device of claim 2, wherein to extract the plurality of target instances, the image signal processor is further configured to:
segment a first image from among the plurality of images into a plurality of first instances corresponding to the plurality of objects;
based on determining that a first instance from among the plurality of first instances satisfies the predetermined condition with respect to a first object from among the plurality of objects, extract the first instance as a first target instance; and
update a first indicator corresponding to the first object from among the plurality of objects to indicate that the first target instance has been extracted.

6. The electronic device of claim 5, wherein to extract the plurality of target instances, the image signal processor is further configured to:
after the first indicator is updated, segment a second image from among the plurality of images into a plurality of second instances corresponding to the plurality of objects;
based on determining that a second instance from among the plurality of second instances satisfies the predetermined condition with respect to a second object from among the plurality of objects, extract the second instance as a second target instance; and
update a second indicator corresponding to the second object from among the plurality of objects to indicate that the second target instance has been extracted.

7. The electronic device of claim 6,
wherein the image signal processor is further configured to:
based on receiving a user input corresponding to the first indicator after the first indicator is updated, update the first indicator to indicate that an additional first target instance is to be extracted,
segment a third image from among the plurality of images into a plurality of third instances corresponding to the plurality of objects;
based on determining that a third instance from among the plurality of third instances satisfies the predetermined condition with respect to the first object from among the plurality of objects, extract the third instance as the additional first target instance; and
update the first indicator to indicate that the additional first target instance has been extracted, and
wherein the fused image comprises the first target instance and the additional first target instance.

8. The electronic device of claim 1, wherein to generate the fused image, the image signal processor is further configured to perform at least one from among a frame alignment between the plurality of target instances, a brightness matching among the plurality of target instances, a color matching among the plurality of target instances, and inpainting a missing portion of at least one of the plurality of target instances.

9. The electronic device of claim 1, wherein the plurality of objects comprise a plurality of humans, and
wherein the predetermined condition corresponds to at least one of a pose and a facial expression associated with the plurality of humans.

10. The electronic device of claim 9, wherein the at least one of the pose and the facial expression is determined based on a user input received from a user of the electronic device.

11. The electronic device of claim 1, wherein to perform at least one from among the segmenting the plurality of images, the determining that the plurality of target instances satisfy the predetermined condition, and the generating of the fused image, the image signal processor is further configured to provide the plurality of images to an artificial intelligence (AI) model.

12. A method for generating a group image, the method being executed by at least one processor of an electronic device, and comprising:
obtaining a plurality of images comprising a plurality of objects;
while the plurality of images are being obtained:
segmenting the plurality of images into a plurality of instances, wherein each instance from among the plurality of instances represents an object from among the plurality of objects;
extracting a plurality of target instances from among the plurality of instances based on determining that the plurality of target instances satisfy a predetermined condition corresponding to the plurality of objects; and
based on determining that the plurality of target instances include a target instance that satisfies the predetermined condition for each object included in the plurality of objects, generating a fused image based on the plurality of target instances.

13. The method of claim 12, further comprising displaying a preview image while the plurality of images are being obtained,
wherein the preview image comprises a plurality of indicators corresponding to the plurality of objects, and
wherein each indicator from among the plurality of indicators indicates whether the target instance that satisfies the predetermined condition has been extracted for a corresponding object from among the plurality of objects.

14. The method of claim 13, wherein each indicator comprises a mask overlaid onto the corresponding object, and
wherein at least one of a color and a texture of the mask indicates whether the target instance that satisfies the predetermined condition has been extracted for the corresponding object.

15. The method of claim 13, wherein the extracting the plurality of target instances comprises:
segmenting a first image from among the plurality of images into a plurality of first instances corresponding to the plurality of objects;
based on determining that a first instance from among the plurality of first instances satisfies the predetermined condition with respect to a first object from among the plurality of objects, extracting the first instance as a first target instance; and
updating a first indicator corresponding to the first object from among the plurality of objects to indicate that the first target instance has been extracted.

16. The method of claim 12, wherein the fusing comprises performing at least one from among a frame alignment between the plurality of target instances, a brightness matching among the plurality of target instances, a color matching among the plurality of target instances, and inpainting a missing portion of at least one of the plurality of target instances.

17. The method of claim 12, wherein the plurality of objects comprise a plurality of humans, and
wherein the predetermined condition corresponds to at least one of a pose and a facial expression associated with the plurality of humans.

18. The method of claim 17, wherein the at least one of the pose and the facial expression is determined based on a user input received from a user of the electronic device.

19. The method of claim 12, wherein at least one from among the segmenting the plurality of images, the determining that the plurality of target instances satisfy the predetermined condition, and the generating of the fused image is performed by providing the plurality of images to an artificial intelligence (AI) model.

20. An electronic device, comprising:
a memory configured to store a plurality of images; and
at least one processor configured to, while the plurality of images are being obtained:
receive a user input identifying a plurality of objects included in the plurality of images, and setting a predetermined condition corresponding to the plurality of objects,
segment the plurality of images into a plurality of instances, wherein each instance from among the plurality of instances represents an object from among the plurality of objects,
extract a plurality of target instances from among the plurality of instances based on determining that the plurality of target instances satisfy the predetermined condition, and
based on determining that the plurality of target instances include a target instance that satisfies the predetermined condition for each object included in the plurality of objects, generate a fused image based on the plurality of target instances.
